(19) United States
(12) Patent Application Publication
(10) Pub. No.: US 2001/0012108 A1
(43) Pub. Date: Aug. 9, 2001

(54) METHODS AND APPARATUS FOR THE IN-PROCESS MEASUREMENT OF THIN FILM LAYERS

(76) Inventors: PAUL HOLZAPFEL, TEMPE, AZ (US); ROBERT F. ALLEN, GILBERT, AZ (US); WARREN LIN, FREMONT, CA (US)

Correspondence Address: SNELL & WILMER, ONE ARIZONA CENTER, 400 EAST VAN BUREN, PHOENIX, AZ, 850040001

(21) Appl. No.: 09/024,723

(22) Filed: Feb. 17, 1998

Related U.S. Application Data
(63) Continuation-in-part of application No. 08/687,710, filed on Jul. 26, 1996, now abandoned.

(51) Int. Cl. G01B 11/06

(52) U.S. Cl. 356/630

(57) ABSTRACT

The present invention provides methods and apparatus which permit the in-process, in-situ, substantially real time measurement of the actual thickness of a surface layer of a work piece, for example, a semiconductor wafer or the like. The present invention generally comprises a probe disposed proximate to the outer perimeter of a polishing pad on a CMP table, such that the probe establishes optical contact with the wafer surface as a portion of the wafer extends beyond the outer perimeter of the polishing pad. The present invention may further comprise a nozzle which applies a stream of compressed air at the disk surface under inspection, to remove excess slurry from the local region of the workpiece being inspected. A broad band light source, namely a tungsten halogen light, is employed in conjunction with a fiber optic cable to direct light at the wafer surface. A bifurcated probe is employed such that the light applied to the workpiece surface is reflected back to and captured by a corresponding optical sensor connected to a fiber optic cable. The captured reflected light received by the receptor sensor and fiber optic cable assembly is applied to a photospectrum meter which analyzes the reflected light. An output signal from the photospectrum meter is transmitted to a processor which includes a smart algorithm configured to calculate the thickness of the surface layer.

### RELATED APPLICATION

This application is a Continuation-In-Part of U.S. application Ser. No. 08/687,710, filed Jul. 26, 1996, the entire content of which is incorporated by reference herein.

### TECHNICAL FIELD

The present invention relates, generally, to methods and apparatus for measuring the thickness of an oxide layer on a semiconductor workpiece during the planarization process and, more particularly, to a technique for transmitting a broad band light source at the surface of the workpiece to be measured, and analyzing the reflection of the light source to obtain real time layer thickness information.

### BACKGROUND ART AND TECHNICAL PROBLEMS

The production of integrated circuits begins with the creation of high-quality semiconductor wafers. During the wafer fabrication process, the wafers may undergo multiple masking, etching, and dielectric and conductor deposition processes. Because of the high-precision required in the production of these integrated circuits, an extremely flat surface is generally needed on at least one side of the semiconductor wafer to ensure proper accuracy and performance of the microelectronic structures being created on the wafer surface. As the size of the integrated circuits continues to decrease and the density of microstructures on an integrated circuit increases, the need for precise wafer surfaces becomes more important. Therefore, between each processing step, it is usually necessary to polish or planarize the surface of the wafer to obtain the flattest surface possible.

For a discussion of chemical mechanical planarization (CMP) processes and apparatus, see, for example, Arai, et al., U.S. Pat. No. 4,805,348, issued February 1989; Arai, et al., U.S. Pat. No. 5,099,614, issued March, 1992; Karlsrud et al., U.S. Pat. No. 5,329,732, issued July, 1994; Karlsrud, U.S. Pat. No. 5,498,196, issued March, 1996; and Karlsrud et al., U.S. Pat. No. 5,498,199, issued March, 1996.

Such polishing is well known in the art and generally includes attaching one side of the wafer to a flat surface of a wafer carrier or chuck and pressing the other side of the wafer against a flat polishing surface. In general, the polishing surface comprises a horizontal polishing pad that has an exposed abrasive surface of, for example, cerium oxide, aluminum oxide, fumed/precipitated silica or other particulate abrasives. Polishing pads can be formed of various materials, as is known in the art, and which are available commercially. Typically, the polishing pad may be a blown polyurethane, such as the IC and GS series of polishing pads available from Rodel Products Corporation in Scottsdale, Ariz. The hardness and density of the polishing pad depends on the material that is to be polished.

During the polishing or planarization process, the workpiece or wafer is typically pressed against the polishing pad surface while the pad rotates about its vertical axis. In addition, to improve the polishing effectiveness, the wafer may also be rotated about its vertical axis and oscillated back and forth over the surface of the polishing pad. It is well known that polishing pads tend to wear unevenly during the polishing operation, causing surface irregularities to develop on the pad. To ensure consistent and accurate planarization and polishing of all workpieces, these irregularities must be removed.

A well prepared polishing pad facilitates the uniform, high-precision planarization of workpieces. This is particularly important when polishing down the oxide layer on a semiconductor wafer during the manufacture of integrated circuit chips.

Presently known methods for measuring the thickness of an oxide layer on a semiconductor wafer involve measuring the total thickness of an applied oxide layer, determining the desired thickness of the oxide layer after planarization, calculating the pressure to be applied during the polishing or planarization process, and further calculating the approximate time required to remove a predetermined amount of oxide layer for a given pressure and slurry combination. Once the desired removal rate (often expressed in nanometers per minute) is ascertained, a statistical inference is employed to determine the approximate amount of time necessary to remove a desired amount of material. After the wafers have undergone planarization for an amount of time calculated to remove a desired thickness of the oxide layer, the workpieces are removed from the machine and the actual thickness of the oxide layer is measured, for example, through the use of laser interferometric techniques. If it is determined that the oxide layer is still too thick after initial planarization, the workpieces must be reinstalled onto the CMP machine for further oxide layer removal. If, on the other hand, an excessive amount of oxide layer has been removed, it may be necessary to scrap the disks, resulting in substantial unnecessary costs.

Further the methods of calculating oxide layer thicknesses currently known in the art are only useful for non-patterned wafers, and generally do not work on wafers having a substantially repeating surface pattern.

A technique is thus needed which accurately measures the oxide layer (and particularly the end point) thickness which overcomes the shortcoming of the prior art.

### SUMMARY OF THE INVENTION

The present invention provides methods and apparatus for measuring the thickness of layers on workpiece surfaces which overcome many of the shortcomings of the prior art.

In accordance with one aspect of the present invention, apparatus and methods are presented which permit the in-process, in-situ, substantially real time measurement of the actual thickness of a surface layer of a workpiece under inspection, for example, a semiconductor wafer (either patterned or non-patterned), or the like. In accordance with a preferred embodiment of the present invention, a probe is disposed proximate the outer perimeter of the polishing pad on a CMP table, such that the probe establishes optical contact with the wafer surface as a portion of the wafer extends beyond the outer perimeter of the polishing pad. A preferred embodiment also applies a stream of compressed air at the disk surface under inspection, to remove excess slurry from the local region of the workpiece being inspected and prevents the slurry from contacting the probe.

In accordance with a further aspect of the present invention, a tungsten halogen light source is employed in conjunction with a fiberoptic cable to direct a broad band light source at the wafer surface. Of course, any suitable broad band light source may be used with the present invention, e.g., a mercury vapor source or a sodium vapor source. In a particularly preferred embodiment, a bifurcated fiber probe is employed, such that the light applied to the workpiece surface is reflected back to and captured by a corresponding fiberoptic sensor and cable immediately proximate the light source cable. The captured, reflected light received by the receptor fiberoptic cable is applied to a high speed CCD (Charge Coupler Device) array-based photospectrum meter which spectroscopically analyzes the reflected light. An output signal from the photospectrum meter is applied to a processor which includes a smart algorithm configured to calculate the thickness of the oxide layer.

In accordance with a further aspect of the present invention, the oxide layer thickness as a function of time is displayed on a view screen for convenient observation by the operator of the machine.

In accordance with a further aspect of the present invention, a plurality of similarly configured probes are used in conjunction with a single CMP machine, such that each workpiece on the machine may be sampled independently of the other workpieces. In this way, the processing time, processing pressure and other parameters for the various workpieces may be independently controlled to achieve optimum oxide layer thickness for each workpiece.

In accordance with yet a further aspect of the present invention, additional software may be incorporated into the controller to which the output of the photospectrum meter is applied, to thereby accurately predict the amount of time remaining and the planarization pressure needed to achieve an optimum end point oxide layer thickness.

In accordance with yet another embodiment of the present invention the bifurcated probe assembly may be attached to a slidable lock-in mechanism which holds the probe at a specific radial point on the wafer so that the probe's field of view traverses the wafer in a substantially circular pattern.

### BRIEF DESCRIPTION OF THE DRAWING FIGURES

The present invention will hereinafter be described in conjunction with the appended drawing figures, wherein like numerals denote like elements, and:

FIG. 1 is a perspective view of an exemplary CMP machine upon which the probe of the present invention is suitably installed;

FIG. 2 is a top view of the CMP machine of FIG. 1, showing an exemplary orientation of the probe assemblies of the present invention;

FIG. 3 is a schematic view of a probe in accordance with the present invention configured to sample the surface of a wafer, including a light source, photospectrum meter, controller, and display;

FIG. 4 is an end view of an exemplary bifurcated probe assembly having a plurality of illuminators and a receiver probe;

FIG. 5 is a schematic view of the probe of FIGS. 3 and 4 sampling an individual die structure of a wafer;

FIG. 6 is a view of one side of a wafer having a plurality of microelectronic die structures disposed thereon;

FIG. 7 is a top view of an exemplary embodiment of a wafer carrier lock-in mechanism in accordance with the present invention;

FIG. 8 is a side view of the lock-in mechanism of FIG. 7;

FIG. 9 is a side view of the lock-in mechanism of FIGS. 7 and 8 with a carrier and wafer assembly in operative engagement with the lock-in mechanism; and

FIG. 10 is a graphical representation of two exemplary signal intensity versus wavelength plots that may be employed by the present invention.

### DETAILED DESCRIPTION OF PREFERRED EXEMPLARY EMBODIMENTS

The subject invention relates to the in-process detection of characteristics of a layer on a workpiece using a broad spectrum light source, a photospectrum meter, and a controller including a smart algorithm for translating the output of the photospectrum meter to a human readable display relating to the workpiece being examined. The preferred embodiment set forth herein relates to the detection of oxide layer thickness on a semiconductor wafer (either patterned or non-patterned); it will be appreciated, however, that the principles of the present invention may be employed to ascertain any number of characteristics associated with a workpiece surface, including end point detection, the detection of surface irregularities, planarity, and the like.

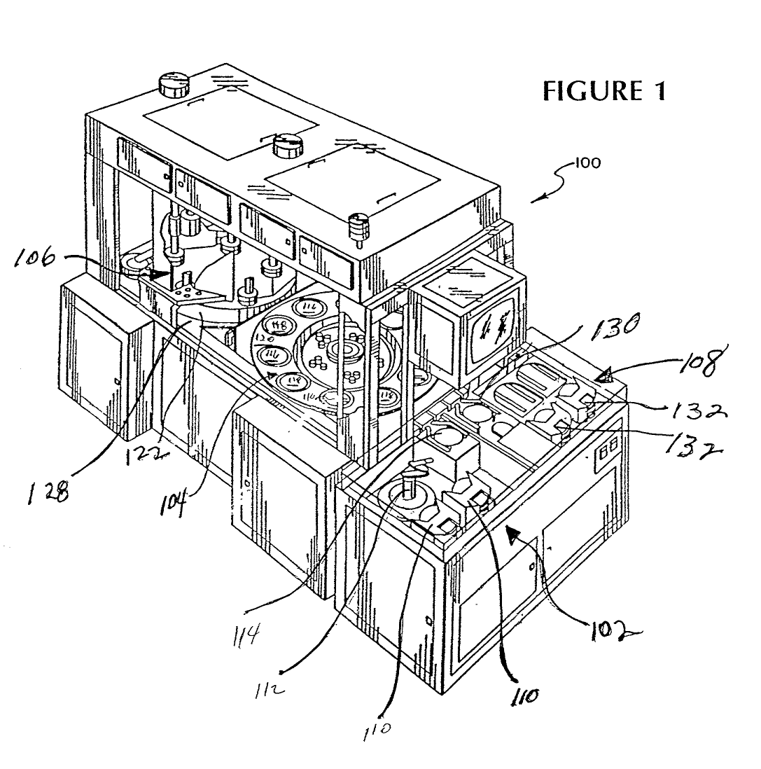

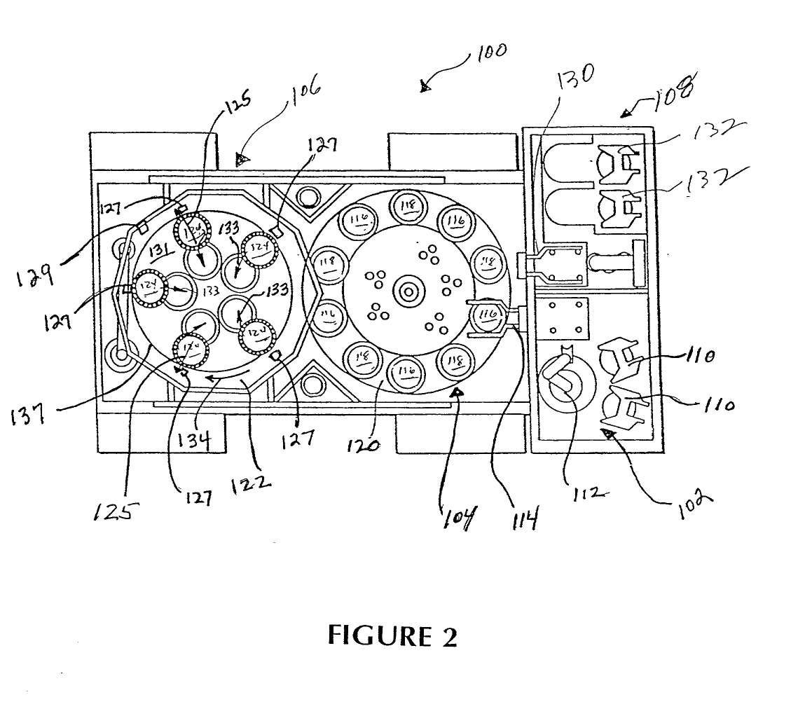

Referring now to FIGS. 1-2, a wafer polishing apparatus 100 is shown embodying the present invention. Wafer polishing apparatus 100 suitably comprises a multiple head wafer polishing machine which accepts wafers from a previous processing step, polishes and rinses the wafers, and reloads the wafers back into wafer cassettes for subsequent processing.

Discussing now the polishing apparatus 100 in more detail, apparatus 100 comprises an unload station 102, a wafer transition station 104, a polishing station 106, and a wafer rinse and load station 108.

In accordance with a preferred embodiment of the invention, cassettes 110, each holding a plurality of wafers, are loaded into the machine at unload station 102. Next, a robotic wafer carrier arm 112 removes the wafers from cassettes 110 and places them, one at a time, on a first wafer transfer arm 114. Wafer transfer arm 114 then sequentially lifts and moves each wafer into wafer transition section 104. That is, transfer arm 114 suitably places an individual wafer on one of a plurality of wafer pick-up stations 116 which reside on a rotatable table 120 within wafer transition section 104. Rotatable table 120 also suitably includes a plurality of wafer drop-off stations 118 which alternate with pick-up stations 116. After a wafer is deposited on one of the plurality of pick-up stations 116, table 120 rotates so that a new station 116 aligns with transfer arm 114. Transfer arm 114 then places the next wafer on the new empty pick-up station 116. This process continues until all pick-up stations 116 are filled with wafers. In the illustrated embodiment of the invention, table 120 includes five pick-up stations 116 and five drop-off stations 118.

Next, a wafer carrier apparatus 122, comprising individual wafer carrier elements 124, suitably aligns itself over table 120 so that respective carrier elements 124 are positioned directly above the wafers which reside in respective pick-up stations 116. The carrier apparatus 122 then drops down and picks up the wafers from their respective stations and moves the wafers laterally such that the wafers are positioned above polishing station 106. Once above polishing station 106, carrier apparatus 122 suitably lowers the wafers, which are held by individual elements 124, into operative engagement with a polishing pad 126 which sits atop a lap wheel 128. During operation, lap wheel 128 causes polishing pad 126 to rotate about its vertical axis. At the same time, individual carrier elements 124 spin the wafers about their respective vertical axes and oscillate the wafers back and forth across pad 126 (substantially along arrow 133) as they press against the polishing pad. In this manner, the under surface of the wafer is polished or planarized.

After an appropriate period of time, the wafers are removed from polishing pad 126, and carrier apparatus 122 transports the wafers back to transition station 104. Carrier apparatus 122 then lowers individual carrier elements 124 and deposits the wafers onto drop-off stations 118. The wafers are then removed from drop-off stations 118 by a second transfer arm 130. Transfer arm 130 suitably lifts each wafer out of transition station 104 and transfers them into wafer rinse and load station 108. In the load station 108, transfer arm 130 holds the wafers while they are rinsed. After a thorough rinsing, the wafers are reloaded into cassettes 132, which then transports the subsequent stations for further processing or packaging.

Although CMP machine 100 is shown having five polishing stations, it will be appreciated that the present invention may be employed in the context of virtually any number of polishing stations. Moreover, the present invention may also be employed in circumstances where not all of the polishing stations are functioning at a time. For example, many standard wafer cassettes carry twenty-four individual workpieces in a single cassette. Consequently, because there are often five workpiece chucks on a single CMP machine, often times the last four disks within a cassette are polished at one time, leaving the fifth disk-holder empty.

With continued reference to FIG. 2, an optical probe assembly 127 is suitably configured near the outer perimeter edge of polishing pad 126 proximate each carrier element 124. More particularly, in a preferred embodiment of the present invention, each respective carrier element suitably oscillates back and forth along arrow 133; each carrier element 124 also suitably rotates a workpiece about the vertical axis of carrier element 124. At the same time, lap wheel 128 and pad 126 are advantageously configured to rotate about their vertical axis, for example, in a counter clockwise direction as indicated by arrow 134.

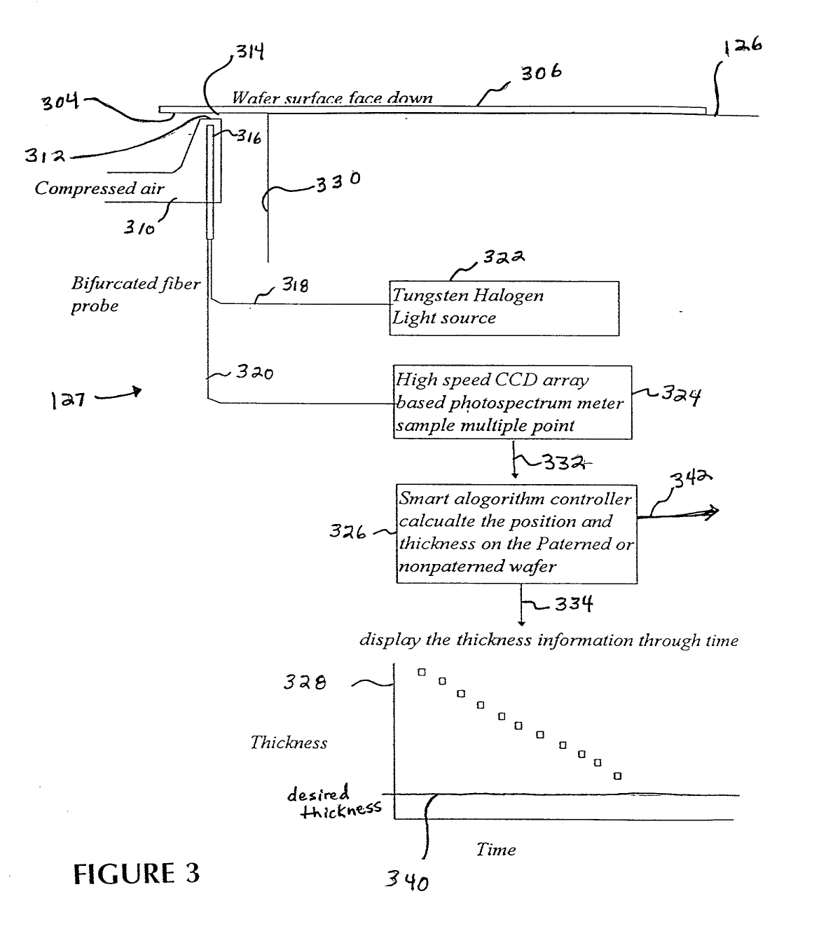

In accordance with a particularly preferred embodiment, each carrier element 124 is suitably configured to periodically extend radially outward from the center of table 126 along arrow 125 such that at least a portion of the outside radius of each workpiece extends beyond the outer edge 137 of table 126. By crossing the outer edge of polishing table 126, surface material thicknesses and desirable material removal rates may be obtained for the workpieces. As a workpiece extends beyond the outer perimeter of the polishing pad, along line 125, the bottom facing surface of the workpiece may be conveniently optically engaged by probe assembly 127, as described in greater detail below in conjunction with FIG. 3.

In accordance with a further aspect of the present invention, apparatus 100 may be configured with a probe assembly 129 useful for detecting the presence of a wafer or wafer fragment on polishing pad 126 during the polishing process. In accordance with this aspect of the invention, if a wafer or wafer fragment is detected on the pad at an inappropriate time, the CMP machine 100 will shut down. A detailed discussion of the operation of probe assembly 129 is discussed in detail in Holzapfel et al U.S. patent application Ser. No. 08/683,150, filed on Jul. 17, 1996, and entitled Methods and Apparatus for the In-Process Detection of Workpieces in a CMP Environment.

Referring now to FIG. 3, an exemplary embodiment of probe assembly 127, in accordance with the present invention, suitably comprises a housing 310 having a nozzle 312 through which compressed air is suitably directed at the under surface of a workpiece (e.g., semiconductor wafer disk) 306, a bifurcated fiber probe 316, a light source 322, a photospectrum analyzer 324, a controller/processor 326, and a display 328.

As best seen in FIG. 3, an exemplary workpiece 306 is shown being polished by polishing pad 126 as described above in conjunction with FIGS. 1 and 2. For clarity, carrier element 124 and other components are omitted from FIG. 3. Probe assembly 127 is suitably mounted proximate the outer perimeter 330 of pad 126, such that nozzle 312 may be directed at a bottom surface 304 of workpiece 306 when at least a portion of the workpiece extends off the perimeter edge of polishing pad 126.

In accordance with a particularly preferred embodiment of the present invention, a supply of compressed air, for example in the range of 0 to 20 PSI and most preferably about 5 PSI, is urged through housing 310 and nozzle 312 to clear away slurry from an exemplary region 314 on undersurface 304 under examination. As the compressed air clears away slurry from the underside of the workpiece, probe 316 suitably outputs a broad band (e.g., white light) light source at region 314; a portion of the light emitted by probe 316 is reflected or scattered back from region 314 and captured by probe 316. In a preferred embodiment, the light output by probe 316 suitably passes through a collimating lens 408 which collimates the light (see FIG. 5). Thus, while a cross-sectional area of light source (probe) 316 is suitably in the range of 0.1 to 10.0 square millimeters and preferably about 1.0 square millimeter, collimating lens 408 is suitably configured to project the light to cover a region 314 on the wafer undersurface that suitably comprises an area in the range of about 10.0 to about 30.0 square millimeters, and preferably about 20.0 square millimeters.

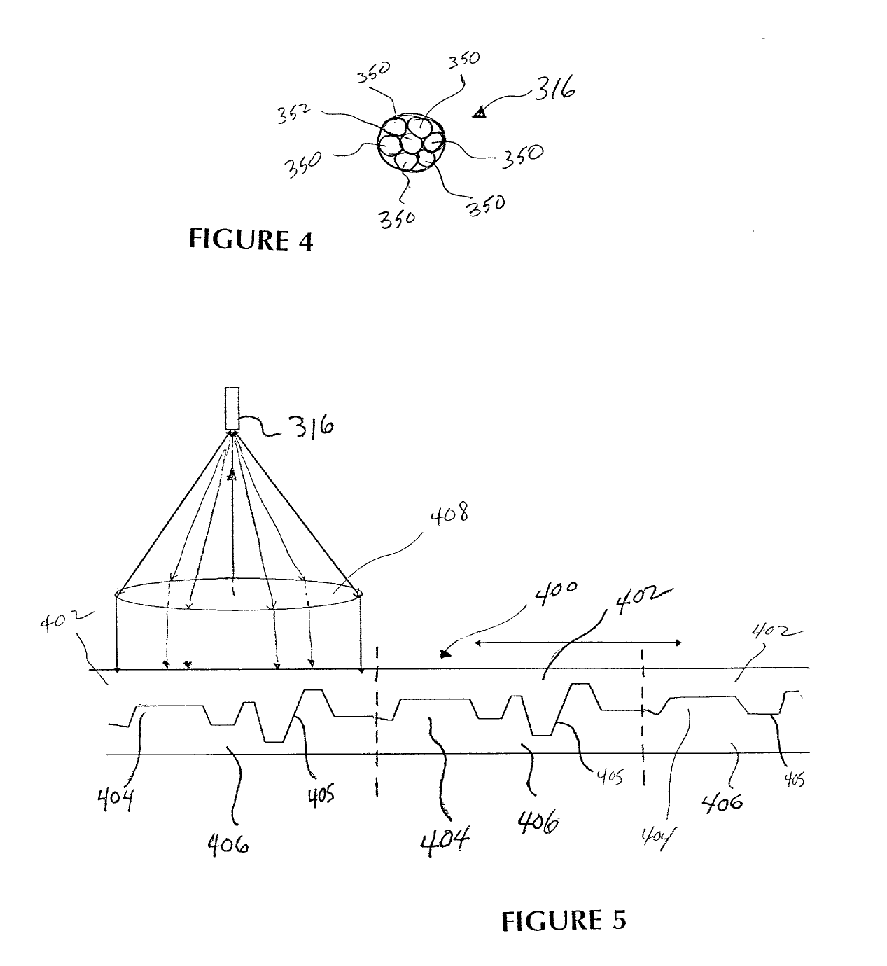

More particularly and with continued reference to FIGS. 3 and 4, probe 316 suitably comprises a plurality of light illuminators 350 and a single receiver probe 352. In accordance with this aspect of the present invention, probe 316 preferably comprises a plurality of (e.g. six) illuminators 350 suitably configured around a single receiver probe 352 disposed in the center of the illuminators. In accordance with this aspect of the present invention, illuminators 350 may be suitably be grouped in a hexagonal configuration. The diameter of each illuminator 350 and the receiver probe 352, as shown in FIG. 4, is suitably about 100 to about 300 microns and preferably about 200 microns. Accordingly, the diameter of probe 316 is suitably in the range of 0.1 to 5 millimeters, and preferably about 0.5 to about 2 millimeters, and most preferably about 1 millimeter. Probe 316 further comprises a transmitter cable 318 through which light is transmitted from light source 322 to illuminators 350 of probe 316 and onto the undersurface of the workpiece. Similarly, probe 316 suitably comprises a receptor cable 320 which receives light from receiver probe 350 and transmits it to photospectrum meter 324. It will be appreciated that the undersurface of the workpiece may be sampled by probe assembly 127 at any desired rate or the sampling may be substantially continuous.

Although the preferred embodiment of light source 322 has been described in accordance with FIGS. 3 and 4, light source 322 may suitably comprise any source capable of applying a desired light signal (e.g. broadband, narrow band, or substantially monochromatic) to the surface of the workpiece. For example, any suitable source (e.g. a tungsten halogen light source) capable of omitting a broad band light signal, for example having spectral components in the wavelength range of 350 to 2000 nanometers, and most preferably in the wavelength range of 400 to 850 nanometers, is acceptable. In accordance with the present invention, a suitable halogen light source may comprise a model number L73A98, available from the Gilway Corporation of Massachusetts. In accordance with a preferred aspect of the present invention, each broadband interrogation signal includes a plurality of spectral components to enable the present invention to suitably perform a spectroscopic analysis on the reflected and captured signals. As described in more detail below, this feature is an improvement over prior art systems that are limited to relatively narrowband analyses or prior art systems that employ interrogation signals having a single wavelength (such as those generated by laser light sources).

Although cables 318 and 320 suitably comprise fiberoptic cables in the preferred embodiment, virtually any conductor may be employed which satisfactorily delivers an appropriate signal (e.g. a light signal) to the workpiece and captures at least a portion of the signal reflected by the workpiece. Moreover, although the preferred embodiment set forth herein employs a light signal, virtually any convenient modality may be employed to interrogate the surface of the workpiece, e.g., an acoustic signal, magnetic signal, or the like.

Photospectrum meter 324 suitably comprises any circuit capable of interpreting the signal reflected from the undersurface of the workpiece. In a preferred embodiment, photospectrum meter 324 suitably comprises a PCMCIA-based photospectrum meter model number PS1000 available from the Mission Peak Optics Company of Fremont, Calif. Photospectrum meter 324 (and/or any number of processors associated therewith) preferably performs a spectroscopic analysis to determine characteristics of the captured (received) signal for a number of different wavelengths.

Controller 326 suitably comprises any general purpose controller capable of receiving an output signal 332 from meter 324 and calculating various parameters from signal 332. In the preferred embodiment, controller 326 is suitably configured to interpret signal 332 and thereby derive the thickness of the oxide layer present in region 314 of workpiece 306. In a particularly preferred embodiment, controller 326 suitably comprises any general purpose personal computer, for example a PC, available from the Mission Peaks Optics Company of Fremont, Calif.

Controller 326 is also suitably configured to output a signal 334 to display terminal 328. In a preferred embodiment, signal 334 is indicative of the thickness of the oxide layer at region 314; it will be understood, however, that signal 334 may embody any suitable information or characteristics about surface 304 of the workpiece, such that any number of parameters may be conveniently displayed on the screen associated with display module 328. In the illustrated embodiment, a graph of oxide layer thickness versus time is shown.

With continued reference to FIG. 3 display terminal 328 may be suitably configured to display information pertaining to the undersurface of the workpiece, (e.g., the thickness of the oxide layer) in any desired format. In the thickness versus time graph shown in FIG. 3, the remaining processing time necessary to arrive at a desired thickness 340 may be visually assessed by the operator; alternatively, controller 326 may be configured to “predict” the time necessary to arrive at a desired thickness for a given pressure and also to display the remaining time to the operator. Alternatively, the controller may be configured to transmit a second output signal 342 to the main controller of machine 100, for example to vary the pressure or other operating parameter(s) associated with the particular carrier element 124 corresponding to the workpiece under inspection. For example, if it is desired that all workpieces complete their processing at approximately the same time, and wherein one or more of the workpieces are closer to the desired thickness than other workpieces, it may be advantageous to reduce the pressure for those workpieces where less material remains to be removed and/or to increase the pressure for those workpieces where a relatively larger amount of material remains to be removed.

In this regard, the present inventors have determined that typical desired material removal rates of oxide layers on semiconductor wafers generally range from 1,000-5,000 angstroms per minute, and preferably about 2,500 angstroms per minute. By calculating the differences in thickness over different sampling periods, controller 326 may also be suitably configured to generate a real time or average material removal rate. In accordance with a preferred embodiment, controller 326 may suitably be configured to output signal 342 to increase or decrease the removal rate, as desired.

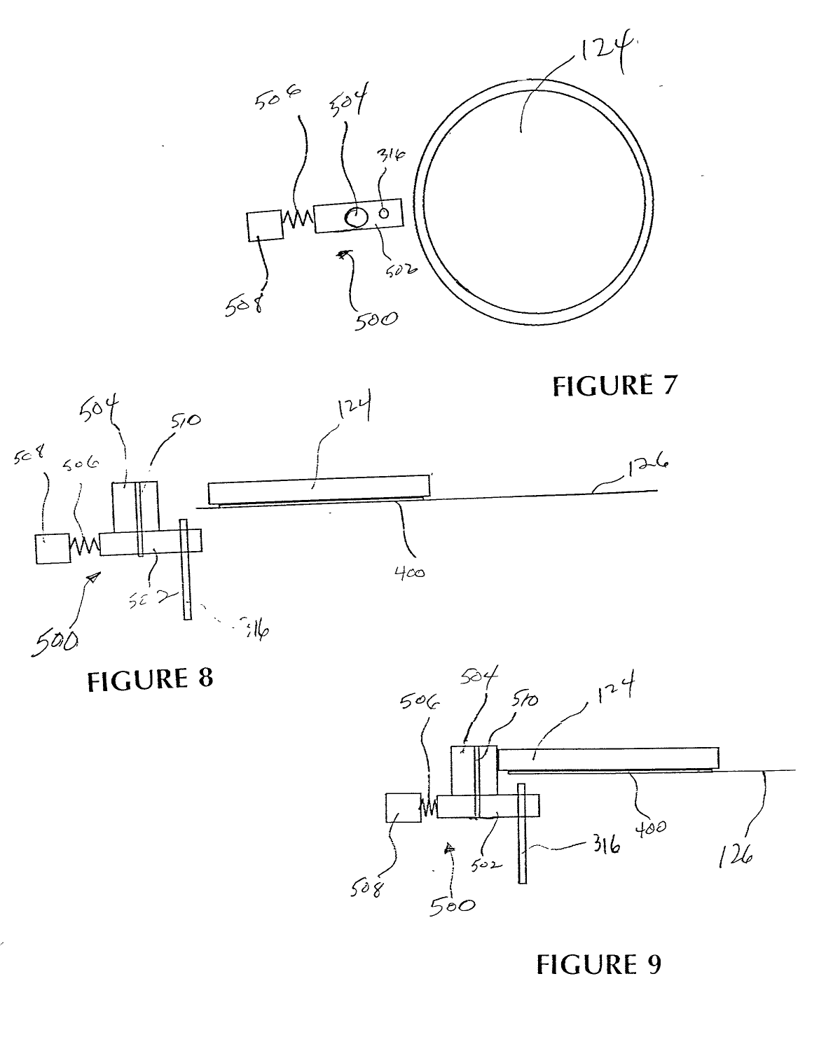

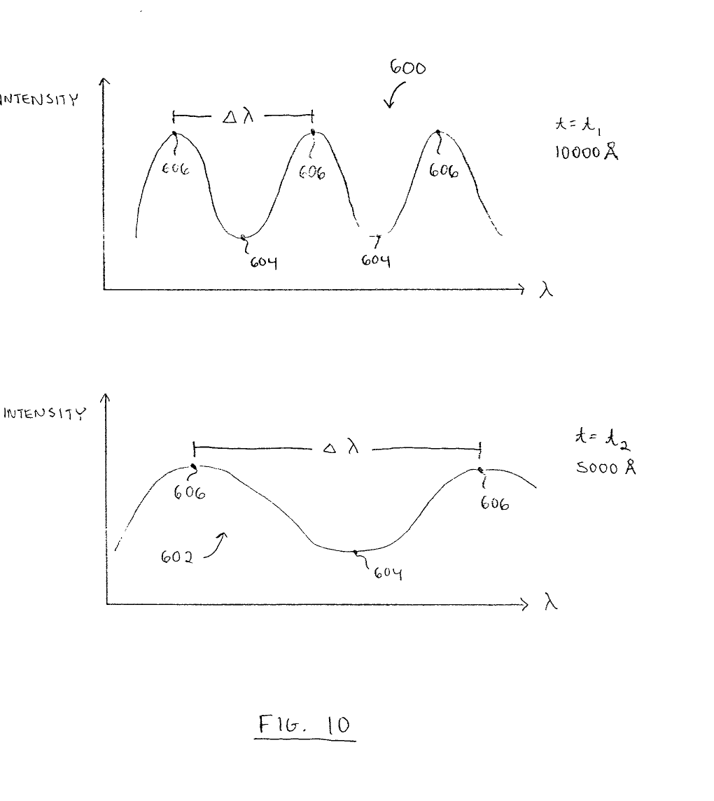

With continued reference to FIG. 3, probe assembly 127 may be mounted to machine 100 in any convenient way, for example, by attaching probe assembly 127 to the frame associated with machine 100 by any suitable fastening mechanism. Indeed, it may be possible to dispose respective probe housings 310 quite close to the surface of the workpiece, for example in the range of 0.1 to 0.5 inches and most preferably about 0.3 inches from the workpiece. Even though this environment may be sprayed by slurry droplets from time to time, the compressed air ejected from housing 310 by nozzle 312 suitably substantially prevents slurry from entering the housing and corrupting probe 316. One preferred embodiment of an exemplary mounting mechanism is discussed in more detail below in conjunction with FIGS. 7-9.

In accordance with a particularly preferred embodiment, probe assembly 127 may be suitably configured to output signal 342 to machine 100 to thereby terminate the processing of a particular workpiece when it is determined that desired thickness 340 has been achieved. In this way, although it still may be desirable to verify the thickness of the oxide layer once the workpieces have been removed, a very high degree of accuracy in the actual thickness of the oxide layer is obtained. In accordance with this aspect of the present invention, the need to place partially completed disks back onto machine 100 for further material removal is substantially eliminated. Similarly, the risk of removing too much of the oxide layer, thus degrading the wafers, is also greatly reduced.

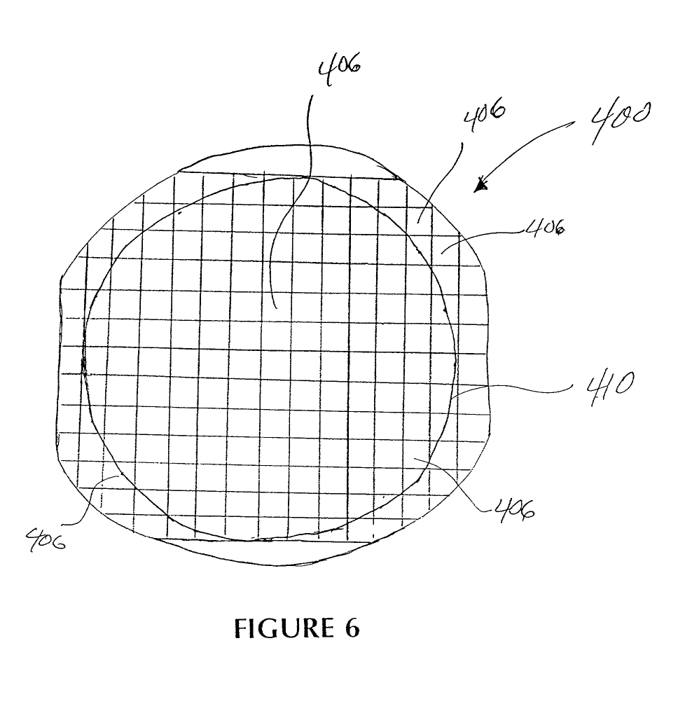

The manner in which probe assembly 127 samples and interprets the scattered light signals to determine wafer surface thickness will now be described in conjunction with FIGS. 5 and 6.

Referring now to FIG. 6, an exemplary embodiment of a wafer surface comprises a plurality of substantially similar die structures arranged in a rectangular grid pattern. As shown in FIG. 5, each individual die structure 406 may comprise in schematic cross section, one or more alternating substrate and oxide layers; for example, a substrate layer 404 and an oxide layer 402. Substrate layer 404 generally comprises a plurality of microelectronic structures substantially defining a substrate topology 405. Because the surface layer or topology 405 of substrate 404 is non-uniform, it is very difficult to accurately determine the thickness of oxide layer 402 at any particular point on the surface of wafer 400. Therefore, to obtain accurate oxide thickness readings, the effect of the non-uniform substrate surface must be minimized or otherwise accounted for. An exemplary wafer surface sampling and analysis method in accordance with the present invention will now be discussed in greater detail.

In accordance with a particularly preferred embodiment of the present invention, light is transmitted from illuminators 350 of probe 316 through collimating lens 408 and onto the undersurface of wafer 400. Generally, part of the transmitted light will be reflected or scattered from oxide layer 402 back to receiver probe 352. However, a substantial portion of the light passes through oxide layer 402 and reflects off the substrate layer 404 (and more particularly, the non-uniform surface 405). As the light is reflected off the substrate and oxide layers, it passes back through collimating lens 408, which essentially focuses the reflected light back to receiver probe 352. The reflected light then passes to photospectrum meter 324 through fiberoptic cable 320. Photospectrum meter 324 then divides the light into discrete bands of predetermined frequency (or wavelength) ranges and converts the light frequency signals into a digital output signal 332 which is communicated to processor/controller 326.

In accordance with a preferred embodiment, processor 326 analyses the converted light frequency signals according to the well-known photo-interference technique using Fresnel's Equation to obtain the thickness of the oxide layer at the sampled area of the wafer surface. In accordance with this aspect of the present invention, the relationship:

4πnd/λ

may be conveniently solved to obtain the oxide thickness, where d=the oxide thickness; n=the refractive index of the sample material (e.g. the oxide layer); and λ=the wavelength of the light.

In the preferred embodiment, processor/controller 326 is further configured to analyze the spectroscopic information obtained by photospectrometer 324 to thereby generate an indication of the thickness of oxide layer 402. As described above, the reflected signal captured by receiver probe 352 is suitably divided by wavelength for subsequent processing. Next, the intensity (or other suitable optical characteristic) of the captured signal is preferably measured at each of the different wavelengths. Alternatively, the present invention may analyze narrow bands of wavelengths and determine a suitable indication of an average or overall intensity associated with such bands.

Processor/controller 326 (or any suitable processor associated with CMP machine 100) may also be configured to generate a plot of the intensity of the captured signal versus the various wavelengths components of the captured signal. FIG. 10 depicts two exemplary plots that may be generated or analyzed for a given workpiece during CMP processing. These plots may be generated and analyzed by processor/controller 326 in an internal manner without any interaction with the operator; these plots may, but need not be, displayed to the operator during processing. Those skilled in the art will appreciate that any number of data processing, conditioning, and formatting techniques may be employed to determine the current intensities and to suitably generate these plots.

A first plot 600 may represent the intensity of a reflected interrogation signal at a particular time (t=t₁) and a second plot 602 may represent the intensity of a reflected interrogation signal at a later time (t=t₂). As indicated in FIG. 10, plot 600 may be associated with a first thickness of oxide layer 402 (e.g., 10,000 Angstroms) and plot 602 may be associated with a second thickness of oxide layer 402 (e.g., 5,000 Angstroms) after further polishing has been performed. Processor/controller 326 is preferably configured to analyze these plots to obtain information indicative of a characteristic, such as the thickness, of oxide layer 402.

Plots 600 and 602 (and other similar plots generated by processor/controller 326) contain distinguishing features that repeat within the range of wavelengths of the spectral components of the received signals. For example, a number of local minima 604 and local maxima 606 may be associated with plots 600 and 602. The present invention takes advantage of the repetitive nature of the local minima 604 and local maxima 606; the repetitive nature is caused by the use of a spectrally rich interrogation signal that contains a broad range of wavelengths. Processor/controller 326 is also configured to suitably identify a plurality of local maxima 606 associated with any given plot. Alternatively, processor/controller 326 may identify a plurality of local minima 604.

In the preferred embodiment, processor/controller identifies two “adjacent” local maxima for the current plot, as shown in FIG. 10. Following such identification, the relative spacing between the two local maxima is determined. This spacing is shown in FIG. 10 as Δλ. In an alternative embodiment, the wavelength spacing between any two local maxima may be determined. It should also be appreciated that the actual quantity determined by processor/controller 326 need not be in units of wavelength; indeed, any suitable quantity may represent this spacing for purposes of analysis and calculation by the present invention. The spacing for a current plot (representing a particular time during workpiece processing) is suitably utilized to estimate the current thickness of oxide layer 402. The inventors have discovered that the thickness of oxide layer 402 can be accurately predicted if the current spacing between local maxima 606 is known.

In contrast to prior art systems, the present invention is capable of providing an accurate measurement of the thickness of a material layer upon the workpiece without requiring an initial thickness to be entered for purposes of relative calculations. In other words, the present invention determines the thickness of oxide layer 402 in an “absolute” manner rather than as a difference between a reference thickness and a current thickness. It should be noted that one or more calibration schemes may be performed to suitably calibrate the relationship between the characteristics of the plots and the thickness of oxide layer 402. Such calibration schemes may be performed in conjunction with ex-situ thickness measurements.

As discussed previously, because the topology of substrate surface 405 is non-uniform, it is very difficult to get an accurate measurement of the thickness of oxide layer 402. Thus, an averaging technique is desirably employed which effectively cancels out many of the effects attributable to the complexity of the substrate layer topology.

The averaging technique will now be discussed in greater detail in conjunction with FIGS. 5 and 6. Referring now to FIG. 6, as discussed previously, an exemplary embodiment of wafer 400 comprises a plurality of die structures 406, each comprising substantially similar or identical substrate topologies. Because of the repeating nature of the die structures, the wafer surface may be advantageously sampled for approximately one full wafer rotation, and the measurements taken during that rotation suitably averaged to largely suppress or even cancel out the effects of the non-uniform topology of the dies. That is, while the sampling of only one die may yield an inaccurate reading of the thickness of the oxide layer, by averaging the sample readings obtained from many similar die structures for one full wafer rotation, the nonuniformity of each die will be effectively cancelled out by the averaging technique, thus giving a more accurate oxide thickness reading.

In accordance with this aspect of the present invention, probe 316 suitably collects between about 50 and about 150 samples for one complete rotation, and preferably about 100 samples. Further, one complete rotation of the wafer generally takes approximately 2 seconds; thus, the sampling rate of probe 316 is suitably between about 100 to about 300 samples per second and preferably about 200 samples per second.

The data for each sample is transmitted to processor 326 which stores and accumulates the data. After sampling a portion (e.g. region 314) of the wafer for approximately one full wafer rotation, the accumulated data (approximately 200 samples) is averaged and one average oxide thickness is calculated, for example using the aforementioned Fresnel technique. In accordance with a particularly preferred embodiment of the invention, all the sampled data for one rotation is added together and averaged and then the oxide layer thickness is calculated from the averaged data. Alternatively, in accordance with yet another preferred embodiment of the invention, an oxide thickness may be calculated for each individual data sample, and thereafter an average thickness calculated from all the individually calculated thicknesses.

In contrast to prior art wafer thickness measurement systems (and as mentioned briefly above), the present invention is capable of interrogating patterned die locations in addition to unpatterned die locations. In particular, probe assembly 127 and its accompanying processes are configured such that any location on the workpiece may be sampled without having to interrogate one or more predetermined reference points. Indeed, prior art systems that employ a single-frequency interrogation signal may only function properly when an unpatterned die is interrogated throughout the thickness measurement procedure. As described above, the nonuniformity of the patterned substrate makes conventional optical measurement techniques ineffective because the characteristics of a narrowband interrogation signal may not be predictable where the interrogation signal reflects from the nonuniform surface.

In accordance with a particularly preferred embodiment, probe assembly 127, and in particular probe 316, is suitably configured to sample the wafer in a substantially circular path 410 (see FIG. 6) so that each die 406 along path 410 is sampled in a substantially uniform manner. That is, because the die structures on the wafer are in a substantially uniform grid pattern and because the field of view of probe 316 suitably corresponds to approximately one die, the probe is likely to sample a complete die structure (as opposed to simply sampling sections of multiple die structures) as it traverses the wafer in a substantially circular pattern. In accordance with this aspect of the present invention, a wafer carrier lock-in mechanism (discussed in detail below) may be used to ensure that the field of view of the probe follows a substantially circular path around the wafer, thus eliminating a spiral reading effect.

Wafer carrier lock-in mechanism 500 will now be discussed in greater detail in conjunction with FIGS. 7-9. An exemplary embodiment of wafer lock-in mechanism 500 preferably comprises a base 502, a rotatable carrier guide 504, a spring 506 and a stopper 508. Rotatable carrier guide 504 is suitably mounted to base 502 with a bearing assembly 510 to permit free rotation of guide 504. Further, spring 506 is suitably mounted between base 502 and stopper 508. Finally, probe 316 is securely mounted within base 502 so that the illuminators and receptor probe are pointed upward toward wafer 400 and wafer carrier element 124.

During operation, wafer carrier 124 rotates about its vertical axis and oscillates back and forth across polishing pad 126. As carrier element 124 oscillates across the pad, a portion of the carrier element periodically extends beyond the edge of the pad, contacting rotating carrier guide 504. Carrier guide 504 suitably rotates about bearing 510 as carrier element 124 rotates, thus minimizing friction between the two elements. Once carrier element 124 contacts guide 504, the field of view of probe 316 becomes fixed at a specific radial point on wafer 400. In accordance with this aspect of the invention, as the carrier and wafer assembly rotate, the field of view of the probe traverses a substantially circular path around the wafer ensuring relatively accurate readings.

In accordance with an exemplary embodiment of the present invention, as the carrier and wafer assembly continue to oscillate further out from the pad, the carrier pushes probe 316, guide 504, and base 502 assembly towards stopper 508, compressing spring 506. Then, as the carrier and wafer assembly begin to oscillate back towards the center of polishing pad 126, the tension in spring 506 causes base 502, carrier guide 504, and probe 316 assembly to remain in contact with and to move with the carrier element and wafer, thus maintaining the position of the probe's field of view on the wafer. Thus, as the lock-in mechanism 500 moves with the carrier and wafer assembly, the probe maintains a substantially circular field of view around the wafer as the carrier and wafer rotate and oscillate back and forth across the pad. Thus, lock-in mechanism 500 prevents the probe from sampling along a less desirable spiral path on the surface of the wafer.

Although the subject invention is described herein in conjunction with the appended drawing figures, it will be appreciated that the invention is not limited to the specific form shown. Various modifications in the selection and arrangement of parts, components, and processing steps may be made in the implementation of the invention. For example, although a preferred embodiment is set forth in which a tungsten halogen light source is used in connection with fiberoptic conductors, it will be appreciated that virtually any interrogation signal may be employed through appropriate conductors, such that in-process, in-situ monitoring of workpiece surface parameters are made available for analyses. Moreover, although the light source, photospectrum meter, controller, and terminal display are illustrated in FIG. 3 in schematic form, it will be appreciated that only the probe 316 need be disposed proximate the workpieces various of the other components, including the light source, photospectrum meter, controller, and screen display may be disposed remotely from the workpiece, as desired. These and other modifications may be made in the design and arrangement of the various components which implement the invention without departing from the spirit and scope of the invention as set forth in the appended claims.

What is claimed is:

1. An apparatus for measuring the thickness of a material layer on a semiconductor wafer during chemical mechanical polishing (CMP) of said wafer, said apparatus comprising:
an optical probe assembly disposed proximate a polishing pad associated with a CMP machine;
a broadband signal source associated with said probe assembly, said broadband signal source being configured to: (a) generate an interrogation signal having a plurality of spectral components, and (b) direct said interrogation signal at a location on a surface of said wafer as said wafer is being processed on said polishing pad;
a receptor associated with said probe assembly, said receptor being configured to receive a captured signal comprising a portion of said interrogation signal that is reflected from said wafer; and
a processor configured to process said captured signal and to generate an output indicative of a characteristic of said material layer.

2. An apparatus according to claim 1, wherein said broadband signal source is configured to generate said interrogation signal such that said interrogation signal includes wavelength components in the range of approximately 350 to 2000 nanometers.

3. An apparatus according to claim 1, wherein said broadband signal source comprises a halogen light source.

4. An apparatus according to claim 1, wherein:
said processor is configured to process a plurality of captured signals associated with a like plurality of interrogation signals directed at a plurality of locations on said surface of said wafer during a current sampling period; and
said output is responsive to said plurality of captured signals.

5. An apparatus according to claim 1, wherein said captured signal includes wavelength components in the range of approximately 350 to 2000 nanometers.

6. An apparatus for measuring the thickness of a material layer formed over a nonuniform substrate layer of a semiconductor wafer, said apparatus comprising:
an optical probe assembly disposed proximate a polishing pad associated with a chemical mechanical polishing (CMP) machine;
a signal source associated with said probe assembly, said signal source being configured to generate and direct an interrogation signal at a surface of said wafer during processing of said wafer by said CMP machine;
a receptor associated with said probe assembly, said receptor being configured to receive a captured signal comprising a portion of said interrogation signal that passes through said material layer and reflects from said nonuniform substrate layer of said wafer; and
a processor configured to process said captured signal and to generate an output indicative of a characteristic of said material layer.

7. An apparatus according to claim 6, wherein said material layer comprises an oxide layer.

8. An apparatus according to claim 6, wherein said signal source is configured to generate said interrogation signal such that said interrogation signal includes a plurality of spectral components.

9. An apparatus according to claim 6, wherein:
said processor is configured to process a plurality of captured signals associated with a like plurality of interrogation signals directed at a plurality of locations on said surface of said wafer during a current sampling period;
said output is indicative of the thickness of said material layer; and
said output is responsive to said plurality of captured signals to thereby account for said nonuniform substrate layer.

10. An apparatus according to claim 6, wherein said processor is further configured to divide said captured signal into a plurality of discrete wavelength bands.

11. A method for measuring the thickness of a material layer on a workpiece during processing of said workpiece by a chemical mechanical polishing (CMP) system, said method comprising the steps of:
applying an interrogation signal from an optical probe assembly to a portion of said workpiece as said workpiece is processed by said CMP system;
receiving a captured signal comprising a portion of said interrogation signal that is reflected from said workpiece;
performing a spectroscopic analysis on said captured signal to determine characteristics of said captured signal at different wavelengths; and
generating an output indicative of a characteristic of said material layer in response to said spectroscopic analysis.

12. A method according to claim 11, wherein said performing step comprises the steps of:
dividing said captured signal in accordance with a plurality of spectral components; and
measuring the intensity of said captured signal at each of said plurality of spectral components.

13. A method according to claim 11, wherein said interrogation signal comprises a broadband halogen light signal.

14. A method according to claim 11, wherein said receiving step receives a portion of said interrogation signal that passes through said material layer and reflects from a nonuniform substrate layer of said wafer, where said material layer is formed over said nonuniform substrate layer.

15. A system for monitoring processing of a workpiece during a chemical mechanical polishing (CMP) procedure, said system comprising:
an optical probe assembly disposed proximate a polishing pad associated with said CMP system;
a signal source associated with said probe assembly, said signal source being configured to direct an interrogation signal at a location on a surface of said workpiece as said workpiece is being processed on said polishing pad;
a receptor associated with said probe assembly, said receptor being configured to receive a captured signal comprising a portion of said interrogation signal that is reflected from said wafer; and
a processor configured to (a) measure optical characteristics of said captured signal, (b) generate a plot of an optical characteristic of said captured signal versus wavelength components of said captured signal, and (c) analyze said plot to obtain information indicative of a characteristic of a material layer formed on said workpiece.

16. A system according to claim 15, wherein said processor is configured to generate said plot such that said plot conveys signal intensities versus wavelengths of spectral components of said captured signal.

17. A system according to claim 15, wherein said processor is further configured to:
identify a plurality of distinguishing features associated with said plot;
determine a relative spacing between two of said distinguishing features; and
estimate the current thickness of said material layer in response to said relative spacing.

18. A system according to claim 17, wherein said processor is configured to identify a plurality of local maxima associated with said plot.

19. A system according to claim 17, wherein said processor is configured to identify a plurality of local minima associated with said plot.

20. A system according to claim 17, wherein said distinguishing features repeat within the range of wavelengths of said spectral components.

21. A system according to claim 15, wherein said signal source is configured to generate a broadband interrogation signal having a plurality of spectral components.

22. A system according to claim 15, wherein said receptor is configured to receive a portion of said interrogation signal that passes through said material layer and reflects from a nonuniform substrate layer over which said material layer is formed.

23. A method for measuring the thickness of a material layer on a workpiece during chemical mechanical polishing (CMP) of said workpiece, said method comprising the steps of:
applying an interrogation signal from an optical probe assembly to a portion of said workpiece as said workpiece is processed by said CMP system;
receiving a captured signal comprising a portion of said interrogation signal that is reflected from said workpiece;
generating a plot of an optical characteristic of said captured signal versus wavelengths of spectral components of said captured signal; and
analyzing said plot to obtain information indicative of the current thickness of said material layer.

24. A method according to claim 23, wherein said generating step generates a plot of signal intensities versus wavelengths of spectral components of said captured signal.

25. A method according to claim 23, wherein said analyzing step comprises the steps of:
identifying a plurality of distinguishing features associated with said plot;
determining a relative spacing between two of said distinguishing features; and
estimating the current thickness of said material layer in response to said relative spacing.

26. A method according to claim 25, wherein said identifying step identifies a plurality of local maxima associated with said plot.

27. A method according to claim 25, wherein said identifying step identifies a plurality of local minima associated with said plot.

28. A method according to claim 25, wherein said distinguishing features repeat within the range of wavelengths of said spectral components.

29. A method according to claim 23, wherein said applying step applies a broadband interrogation signal having a plurality of spectral components.

30. A method according to claim 23, wherein said receiving step receives a portion of said interrogation signal that passes through said material layer and reflects from a nonuniform substrate layer over which said material layer is formed.
